(19) United States
(12) Patent Application Publication
(10) Pub. No.: US 2009/0257817 A1
(43) Pub. Date: Oct. 15, 2009

(54) ROTARY DEVICE

(75) Inventor: YUNG-HUNG CHU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/417,602

(22) Filed: Apr. 2, 2009

(30) Foreign Application Priority Data
Apr. 10, 2008 (CN) 200810300972.7

(51) Int. Cl. F16C 11/00

(52) U.S. Cl. 403/62

(57) ABSTRACT

A rotary device includes a first member and a second member magnetically and rotatablely connected with the first member by a magnetic force. The magnetic force is capable of automatically adjusting the first member to a target position when the first member is rotated away from an initial position and exceeding a predetermined range relative to the second member.

### BACKGROUND

1. Technical Field

The present disclosure relates to rotary devices, and particularly, to a rotary device with a rotary mechanism.

2. Description of Related Art

Rotary devices, such as bar phones, are ubiquitous. Commonly, a bar phone includes a first member for mounting a display unit thereon, a second member having a keyboard and a camera thereon, and a hinge rotatablely connecting the first member to the second member. The keyboard and the camera are disposed on opposite sides of the second member.

The display unit of the first member and the keyboard of the second member are in the same side. When the user uses the bar phone to take a picture of himself, the second member is rotated thereby having the camera and the display unit facing the user. However, it is inconvenient to rotate the first member and accurately stopping at 180 degrees so as to have the display unit and the camera on the same side.

Therefore, an improved rotary device is needed to address the aforementioned deficiencies and inadequacies.

### BRIEF DESCRIPTION OF THE DRAWINGS

FIG. 1 is an isometric view of a rotary device in accordance with an exemplary embodiment.

FIG. 2 is an exploded view of the rotary device of FIG. 1 from one perspective.

FIG. 3 is an exploded view of the rotary device of FIG. 1 from another perspective.

FIG. 4 is an isometric view of the rotary device in FIG. 1 of a rotated state.

### DETAILED DESCRIPTION OF EXEMPLARY EMBODIMENTS

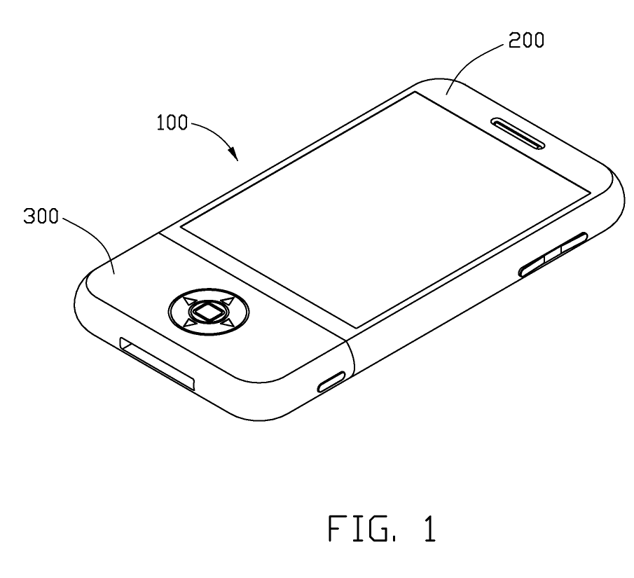

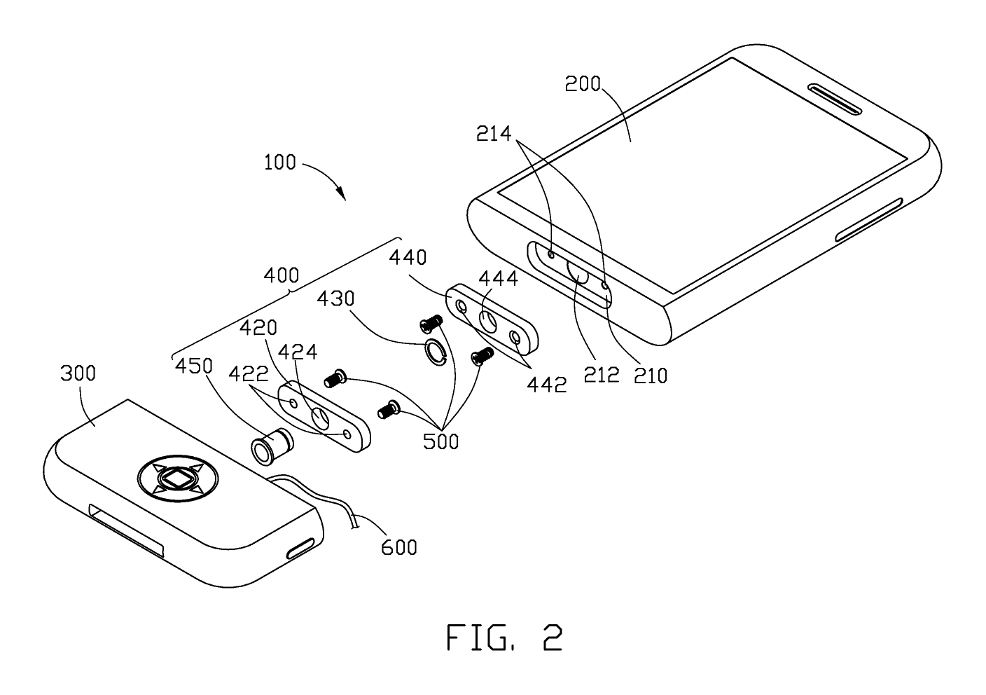

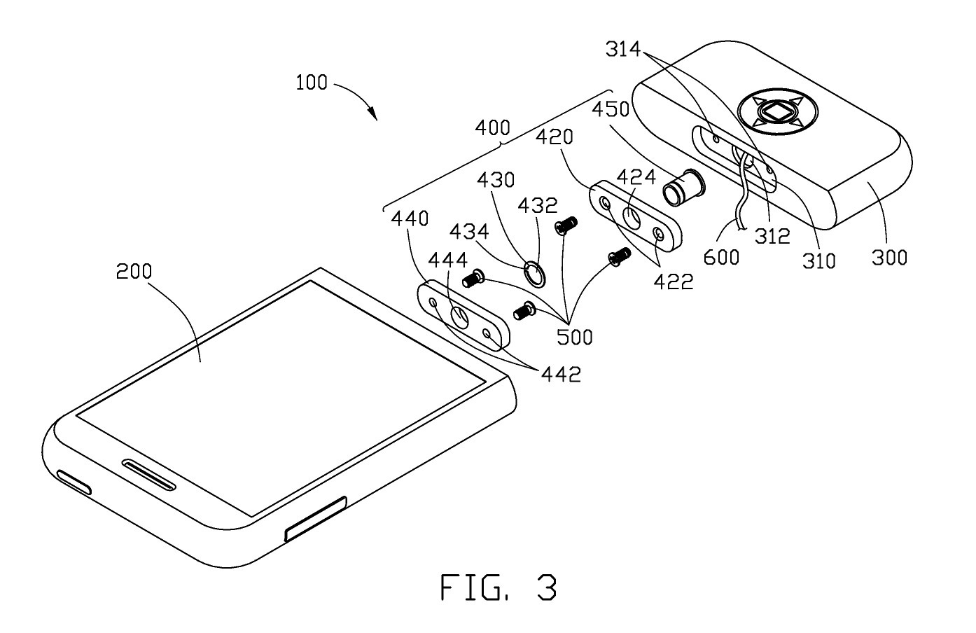

Referring to FIGS. 1 to 3, a rotary device 100 such as a bar phone includes a first member 200, a second member 300, and a rotary mechanism 400. The rotary mechanism 400 rotatably connects the first member 200 to the second member 300. The first member 200 and the second member 300 communicate with each other via a signal cable 600.

The first member 200 is approximately a rectangular cuboid and defines a first receiving space 210 adjacent to the second member 300. Two screw holes 214 are defined in the bottom of the first receiving space 210. A first mounting hole 212 is also defined in the bottom of the first receiving space 210 and between the two screw holes 214.

The second member 300 is similar to the first member 200. The second member 300 is approximately a rectangular cuboid and defines a second receiving space 310 corresponding to the first receiving space 210. Two screw holes 314 are defined in the bottom of the second receiving space 310. A second mounting hole 312 is also defined in the bottom of the second receiving space 310 and between the two screw holes 314.

The rotary mechanism 400 includes a shaft 450, and a first magnetic body 440, a washer 430, and a second magnetic body 420. The shaft 450 is a hollow cylinder with opposite ends inserted into the first mounting hole 212 and the second mounting hole 312, thus the first member 200 and the second member 300 are rotatable around the shaft 450. The first magnetic body 440, the washer 430, and the second magnetic body 420 are sleeved on the shaft 450. The washer 430 is sandwiched between the magnetic bodies 440, 420.

The first magnetic body 440 is engageably received in the first receiving space 210. Two fixing holes 442 are defined in the first magnetic body 440 corresponding to the two screw holes 214 of the first member 200. Two screws 500 threadedly engage with the two screw holes 214 after passing through the two fixing holes 442, correspondingly, to fasten the first magnetic body 440 to the first member 200. As a result, the first magnetic body 440 can rotate together with the first member 200. A through hole 444 is defined in the magnetic body 440 corresponding to the first mounting hole 212 of the first member 200 for allowing the shaft 450 to pass through the first magnetic body 440.

The second magnetic body 420 is engageably received in the second receiving space 310. Two fixing holes 422 are defined in the second magnetic body 420 corresponding to the two screw holes 314 of the second member 300. Two screws 500 threadedly engage with the two screw holes 314 after passing through the two fixing holes 422 correspondingly to fasten the second magnetic body 420 to the second member 300. A through hole 424 is defined in the second magnetic body 420 corresponding to the second mounting hole 312 of the second member 300 for allowing the shaft 450 to pass through the second magnetic body 420. The side of the first magnetic body 440 and the side of the second magnetic body 420 facing each other have different magnetic poles, such that a magnetic attraction force exists between the first magnetic body 440 and the second magnetic body 420.

The washer 430 defines a through hole 432 configured for allowing the shaft 450 to pass through. The washer 430 defines a gap 434 for allowing replacement.

In use, an external force is applied to rotate the first member 200 with the first magnetic body 440 clockwise or counter-clockwise relative to the second member 300 associating with the second magnetic body 420. The magnetic attraction force, generated between the first magnetic body 440 and the second magnetic body 420, may be equilibrated by a friction force generated between the first magnetic body 440 and the second magnetic body 420, thus the first member 200 can be precisely located between an initial position and a target position when the external force is released. It should be noted that the initial position and the target position are determined by the shape of the first magnetic body 420 and the second magnetic body 440. In this embodiment, the first magnetic body 420 and the second magnetic body 420 are strip/bar shaped.

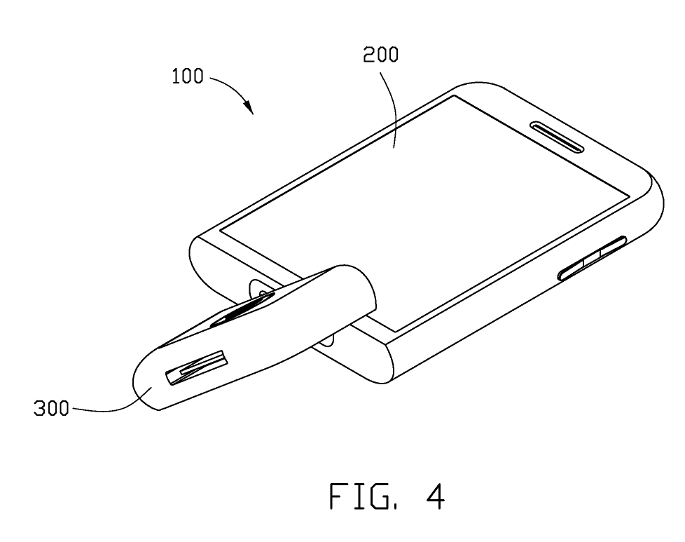

As shown in FIG. 4, the first member 200 rotates with respect to the second member 300. In a first condition, when the first member 200 is rotated relative to the second member 300 within a predetermined range, say between 0 and 90 degrees or 270 to 360 degrees, the magnetic attraction force generated between the first magnetic body 440 and the second magnetic body 420 drives the first member 200 to return to the initial position. In the initial position, a maximum magnetic attraction force is generated between the first magnetic body 440 and the second magnetic body 420, and the first member 200 aligns with the second member 300 at a first angle A1, in this embodiment, this first angle is 0 degrees. In this case, the rotary device 100 can be considered as being in a normal position.

In a second condition, when the first member 200 is rotated relative to the second member 300 not within the predetermined range, that is more than 90 degrees and less than 270 degrees, the magnetic attraction force generated between the first magnetic body 440 and the second magnetic member 440 drives the first member 200 to rotate and rest at the target position. In the target position, a maximum magnetic attraction force is also generated between the first magnetic body 440 and the second magnetic body 420, and the first member 200 aligns with the second member 300 at a second angle A2, in this embodiment, this second angle is 180 degrees. In this case, the rotary device 100 may be used to take a self-portrait, and a preview and/or a photo of the self-portrait taken by a camera (not labeled) attached to the second member 300 may be displayed on the display screen of the first member 200. An input device and the camera may be arranged on opposite sides of the second member 300 correspondingly.

In addition, the first magnetic body 440 and the second magnetic body 420 are still functional after repetitious use. Therefore, a reliability of the rotary device 100 is improved.

Moreover, the washer 430 sandwiched between the first magnetic body 440 and the second magnetic body 420 can decrease friction between the first magnetic body 440 and the second magnetic body 420 when the first member 200 rotates with respect to the second member 300. Therefore, the reliability and work life of the rotary device 100 is further improved.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A rotary device comprising:
a first member;
a second member with respect to which the first member rotates to selectively locate between an initial position and a target position;
a first magnetic body secured to the first member; and
a second magnetic body secured to the second member;
wherein the first magnetic body is structured to cooperate with the second magnetic body to generate a magnetic attraction force to automatically adjust the first member to the initial position when the first member is rotated away from its initial position within a predetermined range, and adjust the first member to the target position when the first member is rotated away from its initial position not within the predetermined range.

2. The rotary device according to claim 1, wherein the initial position, the target position, and the predetermined range are determined by the shape of the first magnetic body and the second magnetic body.

3. The rotary device according to claim 2, wherein the first magnetic body and the second magnetic body are strip shaped; the initial position is 0 degrees; the target position is 180 degrees; the predetermined range is substantially between 0 and 90 degrees and 270 to 360 degrees.

4. The rotary device according to claim 1, further comprising a washer sandwiched between the first magnetic body and the second magnetic body.

5. The rotary device according to claim 4, wherein the washer defines a gap.

6. The rotary device according to claim 1, further comprising a shaft with two ends being rotatablely inserted into the first member and the second member correspondingly, the first magnetic body and the second magnetic body being sleeved on the shaft.

7. The rotary device according to claim 1, wherein the first member defines a receiving space for engageably receiving the first magnetic body.

8. The rotary device according to claim 1, wherein the second member defines a receiving space for engageably receiving the second magnetic body.

9. The rotary device according to claim 1, further comprising a signal cable having two ends electrically connect the first member and the second member correspondingly.

10. A rotary device comprising:
a first member; and
a second member magnetically and rotatablely connected with the first member by a magnetic force and the magnetic force being capable of automatically adjusting the first member to a target position when the first member is rotated away from an initial position and exceeding a predetermined range relative to the second member.

11. The rotary device according to claim 10, further comprising a rotary mechanism rotatablely connecting the first member to the second member, and the magnetic force is provided by the rotary mechanism.

12. The rotary device according to claim 11, wherein the rotary mechanism comprising:
a first magnetic body secured to the first member; and
a second magnetic body secured to the second member cooperated with the first magnetic body to generate the magnetic force.

13. The rotary device according to claim 12, wherein the initial position, the target position and the predetermined range are determined by the shape of the first magnetic body and the second magnetic body.

14. The rotary device according to claim 13, wherein the first magnetic body and second magnetic body are strip shaped; the initial position is 0 degrees, the target position is 180 degrees; the predetermine range is substantially between 0 and 90 degrees and 270 to 360 degrees.

15. The rotary device according to claim 12, wherein the rotary mechanism further comprises a washer sandwiched between the first magnetic body and the second magnetic body.

16. The rotary device according to claim 15, wherein the washer defines a gap.

17. The rotary device according to claim 12, wherein the rotary mechanism further comprises a shaft with two ends being rotatablely inserted into the first member and the second member correspondingly, and the first magnetic body and the second magnetic body are sleeved on the shaft.

18. The rotary device according to claim 12, wherein the first member defines a receiving space for engageably receiving the first magnetic body.

19. The rotary device according to claim 12, wherein the second member defines a receiving space for engageably receiving the second magnetic body.

20. The rotary device according to claim 10, further comprising a signal cable having two ends electrically connect the first member and the second member correspondingly.
